(19) United States
(12) Patent Application Publication
(10) Pub. No.: US 2002/0001473 A1
(43) Pub. Date: Jan. 3, 2002

(54) Film pocket adapted for receiving an image recording medium, and process of making a storage film package

(76) Inventor: Johannes Honerkamp, Hilter (DE)

Correspondence Address: HENRY M FEIEREISEN, 350 FIFTH AVENUE, SUITE 3220, NEW YORK, NY, 10118

(21) Appl. No.: 09/885,837

(22) Filed: Jun. 20, 2001

(30) Foreign Application Priority Data
Jun. 29, 2000 (EP) 00 113 743.9

(51) Int. Cl. G03B 17/26

(52) U.S. Cl. 396/517

(57) ABSTRACT

In a process of making a film package, a photographic film having recorded thereon a plurality of images is cut in a photographic laboratory into a plurality of filmstrips which are placed into a film pocket. Subsequently, the film pocket is sealed on all sides. The thus sealed film pocket can be handed over to a customer together with an index print, whereby the customer can stick the film pocket to the image-free backside of the index print.

### CROSS-REFERENCES TO RELATED APPLICATIONS

This application claims the priority of German Patent Application Serial No. 00 113 743.9, filed Jun. 29, 2000, the subject matter of which is incorporated herein by reference.

### BACKGROUND OF THE INVENTION

The present invention relates, in general, to a film pocket adapted for receiving an image recording medium, such as a photographic negative filmstrip. The present invention also relates to a process of making a storage film package for combining a filmstrip with an index print.

An index print has recorded thereon in small size the positive images corresponding to the negative images on the filmstrip. In this manner, the index print enables a person to clearly see the exact image content on the filmstrip and thereby facilitate reorder of images. The size of the index print depends on the image size which is normally about 10×15 cm or 13×18 cm, and is determinative for the image size on the index print.

Proper reorders require a safekeeping of the film or cut filmstrips to protect them from contamination as a result of dirt, dust, fingerprints etc. Proposals have been made to provide a storage envelope which contains the index print and the filmstrip and is configured in the form of a flat bag. Thus, the storage envelope has a size which approximately corresponds to the size of the index print. This type of storage envelope suffers many shortcomings. Fabrication of such a storage envelope requires much material, significantly increasing the costs. Moreover, it is necessary to insert the filmstrips already in the photographic laboratory into the storage envelope. As the envelope is fairly large, the stacked filmstrips tend to shift relative to one another within the envelope during handling and may become damaged in the package as a result of friction between stacked sides. Also, the filmstrips may easily fall out of the package.

It would therefore be desirable and advantageous to provide an improved storage film package to obviate prior art shortcomings, and to provide an improved process of making a film package in a material-saving and cost-efficient manner to optimize protection of the filmstrips.

### SUMMARY OF THE INVENTION

According to one aspect of the present invention, a process of making a storage unit for several filmstrips, includes the steps of placing in a photographic laboratory several photographic filmstrips, having recorded thereon a plurality of images, in a film pocket; and sealing the film pocket on all sides.

In contrast to prior art film pockets, which received only one filmstrip and remained open so that the protection of the filmstrip was compromised, the present invention provides for a film pocket which contains all the filmstrips of a film and is then sealed all around. Thus, much less material is required so that the film pocket can be produced in a more cost-efficient manner, and the sealed pocket not only optimizes the protection of the filmstrips but also prevents an inadvertent mix-up of filmstrips of different films. Combining the filmstrips of a film can be carried out in a careful manner by a suitable device, which ensured that the filmstrips of a film are safely placed in the film pocket. As the dimension of the film pocket is suited to the size of the filmstrips, a relative shifting of the filmstrips is prevented.

According to another feature of the present invention, the film pocket can be combined with an index print to form a storable film package unit. Suitably, the film pocket is permanently attached to the associated index print.

Although it is basically possible to unite the sealed film pocket with the associated index print in the photographic laboratory, the customer may also combine the film pocket and the index print after receiving these items. In this way, the photographic laboratory saves one processing step, further reducing the overall costs. However, even when the index print is united with the film pocket, the material amount is minimized as the film pocket is only insignificantly greater than the dimensions of the filmstrips.

Joining of the film pocket with the index print can be simplified by providing a layer of the film pocket on the outside with at least one adhesive layer which is self-sticking and suitably covered by a removable masking tape. Before attachment of the film pocket onto the index print, the customer removes the masking tape and sticks the film pocket to the non-image backside of the index print. Suitably, the film pocket has two adhesive layers located in end regions thereof and extending from one longitudinal edge to the other longitudinal edge. This prevents that the end regions or one end region of the film pocket can detach from the index print.

According to another feature of the present invention, the film pockets is made of transparent material, preferably a plastic film.

In the photographic laboratory, the films of several customers can be joined together through an adhesive. In order to be able to differentiate between successive films, the successive films are suitably joined together by an adhesive label which has a film-proximal side provided with an adhesive layer for attachment to the film, and a film-distal side containing a code such as a barcode. Through provision of the code, each film is individualized so that cut filmstrips of one film can be united and associated to a customer's order. A suitable film packaging device is hereby used in the photographic laboratory and includes a cutter to cut a film, reeled off a roll receiving a plurality of successively wound films, into filmstrips. Suitably, the filmstrips have a length corresponding to four negative frames or less. The filmstrips are then stacked by a sorter of the device on top of one another and together inserted through a feed opening into a prefabricated film pocket which has one open side and is reeled off from a drum. After insertion of the filmstrips into the film pocket, the feed opening is sealed by the device and separated from the following, still empty web of film pockets. Normally, the films are cut into filmstrips of four negatives. Occasionally, it may happen that the filmstrip cut last has a shorter length than the other filmstrips.

Combining the filmstrips of a film must be implemented in such a manner that the filmstrip provided with the adhesive label is on the outside and the code faces to the outside. To ensure a control at any time after joining the sealed film pocket with the index print, the filmstrip carrying the adhesive label is so inserted into the film pocket that this filmstrip is positioned adjacent the wall surface so that the code of the adhesive label is visible through the wall surface. Suitably, the web of film pockets is wound on a roll and suitably provided with the adhesive layers and masking tapes, before being filled with filmstrips.

Although it is principally possible to make the sheets of the film pocket in a cost-efficient manner of transparent plastic, it may be suitable to provide one sheet of opaque film whereas the other sheet, adjacent the adhesive label, may be made of a transparent plastic. The sheet of opaque film forms the backside of the film pocket and has on the outside the adhesive layer or layers.

Suitably, the film pockets are prefabricated and wound on a roll which is then attached in the photographic laboratory onto a suitable film packaging device, whereby the film pockets are open at the feed side. This feed opening is then sealed by the device after introduction of the filmstrips, thus optimizing the overall production of the closed film pockets, whereby the prefabrication of the film pockets can be implemented by a suitably dimensioned machine.

### BRIEF DESCRIPTION OF THE DRAWING

Other features and advantages of the present invention will be more readily apparent upon reading the following description of a preferred exemplified embodiment of the invention with reference to the accompanying drawing, in which:

FIG. 1 is a perspective illustration of a storage film package unit according to the present invention; and

FIG. 2 is a perspective illustration of a film packaging device.

### DETAILED DESCRIPTION OF PREFERRED EMBODIMENTS

Throughout all the Figures, same or corresponding elements are generally indicated by same reference numerals.

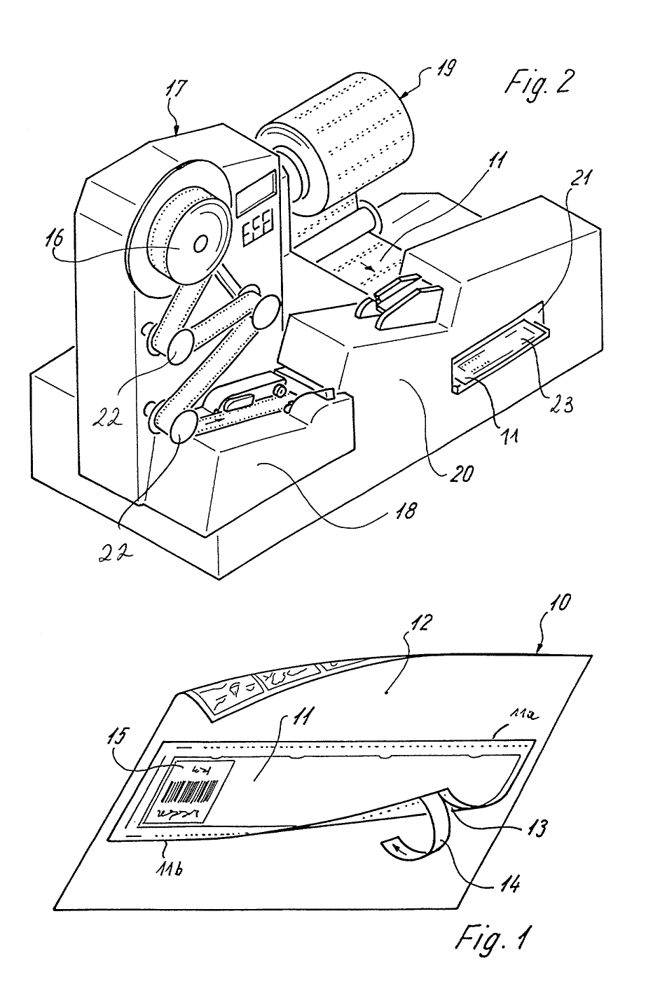

Turning now to the drawing, and in particular to FIG. 1, there is shown a perspective illustration of a storage film package unit according to the present invention, generally designated by reference numeral 10 and including a film pocket 11 attached onto an image-free backside of an index print 12, whereby the film pocket 11 and the index print 12 are placed in back-to-back relationship. The film pocket 11 is made of two sheets joined together by a welding process along three sides at formation of a feed opening for allowing insertion of filmstrips. For convenience and sake of simplicity, much of the following description is made only in relation to a photographic negative filmstrip. However, it will be understood that the principles described in the following description are equally applicable to other image recording media which generally follow the concepts outlined here and thus are considered to be covered by this disclosure.

The sheets of the film pocket 11 may be made of transparent material, such as plastic films of e.g. polyethylene. It is also conceivable that only one sheet, which faces away from the index print 12, may be made of transparent material, whereas the other sheet, i.e. the backside, may be made of opaque material and may have information applied thereon through vapor deposition.

The index print 12 has recorded thereon in small size a plurality of positive images corresponding to the negative images on the filmstrips. The filmstrips are cut from a film and inserted into the film pocket 11 which is then sealed along all sides to protect the filmstrips against dirt, dust or other contamination. The film pocket 11 has a substantially rectangular configuration and has dimensions which are only slightly greater than the dimensions of the inserted filmstrips. The number of filmstrip depends on the length of the film, i.e. on the number of exposures on the film. One of the filmstrips is provided with an adhesive label 15 (FIG. 1) which contains a code, such as a barcode, and is attached to the filmstrip. This filmstrips are so placed into the film pocket 11, that the filmstrip with the attached label 15 is located outermost, with the code of the label 15 facing outwards to be visible through the wall surface of the transparent sheet, when the film pocket 11 is attached to the index print 12.

Although the film pocket 11 is shown in the non-limiting example as having a rectangular configuration, the configuration of the film pocket 11 depends, of course, on the size of the cut filmstrips. However, a film is suitably cut into filmstrips of a four negative frames, thereby accounting for the rectangular configuration of the film pocket 11.

As further shown in FIG. 1, the film pocket 11 is provided on opposite end regions with two self-sticking adhesive layers 13 which extend from one longitudinal edge 11a to the other longitudinal edge 11b. The adhesive layers 13 are each covered by a masking tape 14 which can be removed when attaching the film pocket 11 to the backside of the index print 12.

In the photographic laboratory, the filmstrips are placed into the film pocket 11 and the film pocket 11 is handed together with the associated index print to the customer. The customer can then remove the masking tapes 14 and stick the film pocket 11 to the image-free backside of the index print 12 to establish a film package. Of course, the attachment of the film pocket 11 to the index print 12 may be carried out also by the personnel in the photographic laboratory. In any event, the filmstrips are protected in an optimum fashion and later reorders can easily be implemented by selecting the desired pictures on the index print and associating these pictures with the negative on the filmstrips, normally via corresponding frame numbers. The film pocket 11 is opened in the photographic laboratory, and after completing the order, the filmstrips are placed into a new film pocket 11 and combined with the associated index print 12 to return the film package to the customer.

Turning now to FIG. 2, there is shown a perspective illustration of a film packaging device, generally designated by reference numeral 17 as used in the photographic laboratory. A roll of developed photographic films having recorded thereon a plurality of images is mounted onto a roll-off spool 16 of the film packaging device 17. Normally, the adhesive label 15 is applied in the laboratory onto the film, when the individual films of different customers are wound onto the spool 16, whereby the adhesive labels 15 are also drawn from a roll. The film is routed around pulleys 22 into a cutter 18 for cutting the film into filmstrips 23 which are stacked by a sorter 20 and inserted in superimposed disposition through a feed opening into a film pocket 11 which is reeled off from a drum 19 holding a continuous web of film pockets 11. After insertion of the filmstrips 23 in the film pocket 11, the feed opening is sealed, suitably through a welding process, and the film pocket 11 is separated from the remaining film pockets and discharged through opening 21 of the device 17. The filmstrip carrying the adhesive label 15 is so placed in the film pocket 11 that the code is visible from outside.

It will be appreciated by persons skilled in the art that the film packaging device 17 must contain much mechanical apparatus which does not appear in the foregoing Figures, e.g. means for applying heat for welding purposes, sorting mechanism etc. However, this apparatus, like much other necessary apparatus, is not part of the invention, and has been omitted from the Figures for the sake of simplicity.

The film pockets 11 can be pre-fabricated by a suitable machine and wound onto a roll, whereby initially one of the narrow sides of each film pocket 11 remains open for formation of the feed opening for the filmstrips. After placement of the filmstrip in the film pocket 11, the feed opening is sealed by the apparatus 17.

While the invention has been illustrated and described as embodied in a film pocket adapted for receiving an image recording medium, and process of making a storage film package, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A process, comprising the steps of:
cutting a photographic film, having recorded thereon a plurality of images,
into a plurality of filmstrips;
placing the plurality of filmstrips into a film pocket; and
sealing the film pocket on all sides.

2. The process of claim 1, and further comprising the step of combining an index print with the film pocket for providing a film package, with the index print having recorded thereon positive images corresponding to the images recorded on the filmstrips.

3. The process of claim 2, wherein the combining step includes joining the film pocket with the index print after receiving the film pocket and the index print.

4. The process of claim 2, wherein the film pocket has at least one outer layer of self-sticking adhesive which is covered by a removable masking tape, said combining step including removing the masking tape before joining the film pocket to the index print.

5. The process of claim 4, wherein the film pocket has two lateral end areas, each provided with a one of said outer layer of self-sticking adhesive which extends across the film pocket in a direction transversely to longitudinal edges of the film pocket.

6. The process of claim 1, wherein the film pocket has at least one layer of transparent material.

7. The process of claim 6, wherein the transparent material is a plastic film.

8. The process of claim 1, wherein a plurality of films are joined together in the photographic laboratory by an adhesive label having a film-proximal side, which is coated with a self-sticking adhesive layer, and a film-distal side containing a code.

9. The process of claim 8, wherein the code is a barcode.

10. The process of claim 1, and further comprising the steps of cutting the filmstrip in sections of a maximum length of four negative frames; stacking the sections; and placing the sections together through a feed opening on one side of the film pocket which is received from a roll having wound thereon a series of successive film pockets.

11. The process of claim 10, and further comprising the steps of sealing the film pocket in an area of the feed opening; and separating the film pocket from a subsequent still empty film pocket.

12. The process of claim 8, wherein the filmstrip is so placed into the film pocket that the adhesive label is located in an area adjacent a wall surface so that the code is visible through the wall surface.

13. The process of claim 1, wherein the film pocket has opposite long sides and opposite narrow sides and is so pre-fabricated that one of the narrow sides has a feed opening.

14. The process of claim 13, wherein the film pocket is sealed along the long sides and the other one of the narrow sides.

15. The process of claim 1, wherein the outer layer of self-sticking adhesive includes a covered and nontransparent film.

16. A film pocket, comprising a body portion in the form of two sheets joined together along three sides to thereby define a feed opening for introduction of a filmstrip; at least one self-sticking adhesive applied on one of the sheets; and a removable masking tape covering the adhesive.

17. The film pocket of claim 16, wherein the body portion has a rectangular configuration with two opposite long sides and two opposite narrow side, said adhesive extending near a narrow side in substantially parallel relationship thereto.

18. The film pocket of claim 16, wherein the sheets are made of transparent material.

19. The film pocket of claim 18, wherein the sheets are made of plastic film.

20. The film pocket of claim 16, and further comprising an adhesive label having a filmstrip-proximal side, which is coated with a self-sticking adhesive layer, and a filmstrip-distal side containing a code.

21. In combination:
a filmstrip having recorded thereon a plurality of negative images;
an index print having one side on which are recorded a plurality of positive images corresponding to the images on the filmstrip, and another non-image side; and
a film pocket receiving the filmstrip and attachable to the non-image side of the index print.

22. The combination of claim 21, wherein the film pocket has a body portion in the form of two sheets joined together along three sides to thereby define a feed opening for introduction of a filmstrip; at least one self-sticking adhesive applied on one of the sheets; and a removable masking tape covering the adhesive.

23. The combination of claim 22, wherein the body portion has a rectangular configuration with two opposite long sides and two opposite narrow side, said adhesive extending near a narrow side in substantially parallel relationship thereto.

24. The combination of claim 22, wherein the sheets are made of transparent material.

25. The combination of claim 24, wherein the sheets are made of plastic film.

26. The combination of claim 21, wherein the film pocket includes an adhesive label having a filmstrip-proximal side, which is coated with a self-sticking adhesive layer, and a filmstrip-distal side containing a code.
